(19) United States
(12) Patent Application Publication
(10) Pub. No.: US 2024/0119131 A1
(43) Pub. Date: Apr. 11, 2024

(54) COMMUNICATION APPARATUS, COMMUNICATION METHOD, AND NON-TRANSITORY COMPUTER-READABLE STORAGE MEDIUM

(71) Applicant: NEC Corporation, Tokyo (JP)

(72) Inventors: Keiju NAKAMURA, Tokyo (JP); Hiroaki KISO, Tokyo (JP)

(73) Assignee: NEC CORPORATION, Tokyo (JP)

(21) Appl. No.: 18/390,031

(22) Filed: Dec. 20, 2023

Related U.S. Application Data
(63) Continuation of application No. 18/229,522, filed on Aug. 2, 2023.

(30) Foreign Application Priority Data
Aug. 12, 2022 (JP) 2022-129011

(51) Int. Cl. G06F 21/32; G06F 21/62; G06Q 30/0601

(52) U.S. Cl. CPC G06F 21/32; G06F 21/6209; G06Q 30/0631; G06F 2221/2141

(57) ABSTRACT

A communication apparatus includes an authentication unit and a communication unit. The authentication unit authenticates a target person. The communication unit transmits and receives information to and from a first terminal associated with the target person when the authentication has succeeded. In other words, the communication apparatus performs bidirectional communication with the first terminal. The first terminal is operated by, for example, a different person from the target person. At least a part of information transmitted by the communication unit to the first terminal is related to the target person. Further, at least a part of information received by the communication unit from the first terminal includes information from a person who operates the first terminal to the target person.

This application is a Continuation of U.S. application Ser. No. 18/229,522 filed Aug. 2, 2023, which is based upon and claims the benefit of priority from Japanese Patent Application No. 2022-129011 filed on Aug. 12, 2022, the disclosure of which is incorporated herein in its entirety by reference.

### TECHNICAL FIELD

The present invention relates to a communication apparatus, a communication method, and a program.

### BACKGROUND ART

In recent years, various types of information have been transmitted between terminals. For example, Patent Document 1 (Japanese Patent Application Publication No. 2020-42391) discloses a data processing apparatus for a purpose of notifying a guardian of an image relating to a student. Specifically, the data processing apparatus acquires image data indicating an activity of a student, analyzes the image data, and determines the student associated with the image data. Then, the data processing apparatus generates transmission data including the image data and having, as a transmission destination, a terminal apparatus associated with the determined student.

Note that, Patent Document 2 (Japanese Patent Application Publication No. 2021-49098) discloses an electric wheelchair having the following function. The electric wheelchair includes a sitting seat that moves according to walking of a user and can also be sat by the user, a heart rate sensor that detects a heart rate of the user, a heart rate determination unit that determines whether the detected heart rate is appropriate, and a message output means unit that outputs a predetermined message to the user, based on a determination result by the heart rate determination unit.

### SUMMARY OF INVENTION

In order to assist in communication between a plurality of persons who cannot directly meet, it is preferable to allow bidirectional communication between these persons. However, in Patent Document 1 described above, the bidirectional communication is not taken into consideration.

One example of an object of the present invention is to provide a communication apparatus, a communication method, and a program that can assist in communication between a plurality of persons.

One aspect of the present invention provides a communication apparatus including:
at least one memory configured to store instructions; and
at least one processor configured to execute the instructions to:
   authenticate a target person; and
   transmit and receive information to and from a first terminal being associated with the target person and being operated by a different person from the target person when the authentication has succeeded, wherein
at least a part of information transmitted to the first terminal is related to the target person, and
at least a part of information received from the first terminal includes information from the different person to the target person.

One aspect of the present invention provides a communication method including,
by at least one computer:
authenticating a target person; and
transmitting and receiving information to and from a first terminal being associated with the target person and being operated by a different person from the target person when the authentication has succeeded, wherein
at least a part of the information transmitted to the first terminal is related to the target person, and
at least a part of the information received from the first terminal includes information from the different person to the target person.

One aspect of the present invention provides a program causing a computer to execute:
a process of authenticating a target person; and
a process of transmitting and receiving information to and from a first terminal being associated with the target person and being operated by a different person from the target person when the authentication has succeeded, wherein
at least a part of the information transmitted to the first terminal is related to the target person, and
at least a part of the information received from the first terminal includes information from the different person to the target person.

According to one aspect of the present invention, a communication apparatus, a communication method, and a program that can assist in communication between a plurality of persons can be acquired.

### BRIEF DESCRIPTION OF THE DRAWINGS

FIG. 1 is a diagram illustrating a main part of a communication apparatus according to an example embodiment.

FIG. 2 is a diagram illustrating one example of a usage environment of the communication apparatus.

FIG. 3 is a diagram illustrating one example of a functional configuration of a first terminal.

FIG. 4 is a diagram illustrating one example of a functional configuration of the communication apparatus.

FIG. 5 is a diagram illustrating one example of information stored in a storage unit.

FIG. 6 is a diagram illustrating a hardware configuration example of the communication apparatus.

FIG. 7 is a flowchart illustrating an operation performed by the communication apparatus together with an operation performed by the first terminal and a second terminal.

FIG. 8 is a diagram illustrating a modification example of FIG. 7.

FIG. 9 is a flowchart illustrating a first specific example of step S50.

FIG. 10 is a flowchart illustrating a second specific example of step S50.

FIG. 11 is a flowchart illustrating a third specific example of step S50.

FIG. 12 is a flowchart illustrating a fourth specific example of step S50.

### EXAMPLE EMBODIMENT

Hereinafter, example embodiments of the present invention will be described with reference to the drawings. Note that, in all of the drawings, a similar component has a similar reference sign, and description thereof will be appropriately not included.

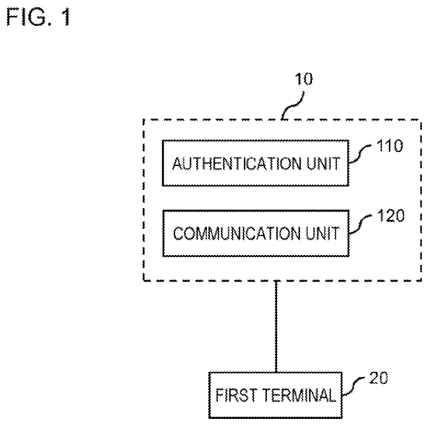

FIG. 1 is a diagram illustrating a main part of a communication apparatus 10 according to an example embodiment. The communication apparatus 10 includes an authentication unit 110 and a communication unit 120. The authentication unit 110 authenticates a target person. The communication unit 120 transmits and receives information to and from a first terminal 20 associated with the target person when the authentication has succeeded. In other words, the communication apparatus 10 performs bidirectional communication with the first terminal 20. The first terminal 20 is operated by, for example, a different person from the target person. At least a part of information transmitted from the communication unit 120 to the first terminal 20 is related to the target person. Further, at least a part of information received by the communication unit 120 from the first terminal 20 includes information from the person who operates the first terminal 20 to the target person. Thus, when the communication apparatus 10 is used, the communication apparatus 10 can assist in communication between the target person, and persons other than the target person, i.e., a plurality of persons.

One example of the person who operates the first terminal 20 is a relative of the target person.

For example, when the target person is a resident in a facility such as a care facility and a hospital, it is difficult for a relative of this resident to readily communicate with the resident. In contrast, when the communication apparatus 10 is used, the relative can easily communicate with the resident. Note that, a similar effect can also be acquired when the target person is a relative of a resident and the first terminal 20 is operated by the resident or an assistant of this resident. Herein, the assistant is, for example, a caregiver in a care facility, or a nurse in a medical institution.

Further, when the target person is a child and the person who operates the first terminal 20 is a guardian of the child, communication between the child or a supervisor (for example, a teacher) of the child, and the guardian can be easily performed.

Details of the communication apparatus 10 will be described below.

In the example illustrated in FIG. 1, the communication apparatus 10 is used together with the first terminal 20. The first terminal 20 is operated by a person other than a target person. Meanwhile, the communication apparatus 10 is operated by the target person or an assistant. In other words, the communication apparatus 10 assists in communication between the target person and the person other than the target person by communicating with the first terminal 20. For example, when the target person is a resident in a facility, the first terminal 20 is operated by a relative of the resident, and the communication apparatus 10 is operated by the resident, a caregiver, or a nurse. Further, when the target person is a relative of a resident in a facility, the first terminal 20 is operated by the resident, a caregiver, or a nurse, and the communication apparatus 10 is operated by the relative of the resident.

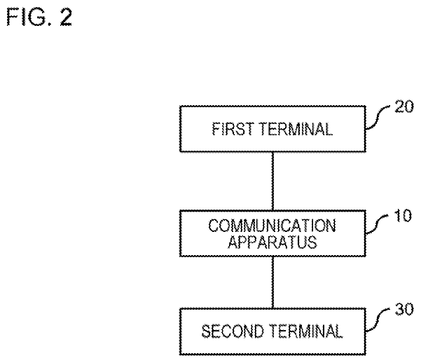

FIG. 2 is a diagram illustrating a second example of a usage environment of the communication apparatus 10. In the example illustrated in FIG. 2, the communication apparatus 10 is used together with a second terminal 30 in addition to the first terminal 20. In this case, one of the communication apparatus 10 and the second terminal 30 is operated by a caregiver or a nurse, and the other is operated by a target person.

Note that, in the example illustrated in FIG. 2, the communication apparatus 10 may be a terminal of a stationary type operated by, for example, a caregiver or a nurse, or may be a cloud server.

Further, in the examples in FIGS. 1 and 2, a cloud server may be further used in addition to the communication apparatus 10, the first terminal 20, and the second terminal 30. In this case, at least a part of processing performed by any of the communication apparatus 10, the first terminal 20, and the second terminal 30 may be performed by the cloud server. When the cloud server is used, the communication apparatus 10 is used together with a terminal being an interface of this cloud server in addition to the cloud server.

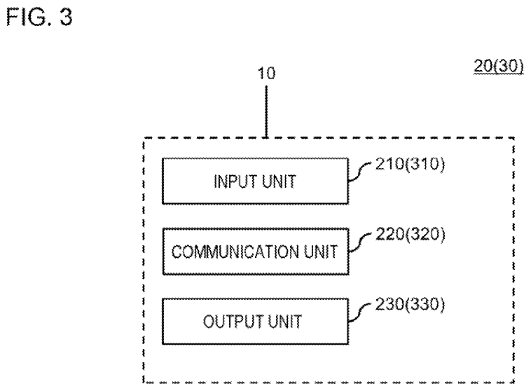

FIG. 3 is a diagram illustrating one example of a functional configuration of the first terminal 20. The first terminal 20 includes an input unit 210, a communication unit 220, and an output unit 230. One example of the first terminal 20 is a portable terminal such as a smartphone and a tablet type terminal.

The input unit 210 also functions as a capturing unit, and various types of information are input. For example, the input unit 210 includes a capturing apparatus, and generates an image. The image may be a moving image, may be a still image, or may include both of a moving image and a still image. Further, the input unit 210 may generate sound data together with an image. Further, text data may be input from a user to the input unit 210.

The communication unit 220 transmits and receives information to and from an external apparatus. One example of the external apparatus is the communication apparatus 10.

The output unit 230 includes an output apparatus, and outputs information by using this output apparatus. One example of this output apparatus is a display such as a touch panel, and a speaker. Note that, when the output unit 230 includes a touch panel, the output unit 230 also functions as an input apparatus operated by a user of the first terminal 20.

A functional configuration of the second terminal 30 illustrated in FIG. 2 is also similar to the functional configuration of the first terminal 20. In other words, the second terminal 30 includes an input unit 310, a communication unit 320, and an output unit 330. The input unit 310 is similar to the input unit 210, the communication unit 320 is similar to the communication unit 220, and the output unit 330 is similar to the output unit 230.

Note that, the first terminal 20 and the second terminal 30 may have another configuration. For example, when iris information, fingerprint information, or vein information is used at a time of authentication by the communication apparatus 10, the first terminal 20 and the second terminal 30 may include an apparatus for acquiring the information. Then, the information acquired by this apparatus is transmitted from the output unit 230 or the output unit 330 to the communication apparatus 10.

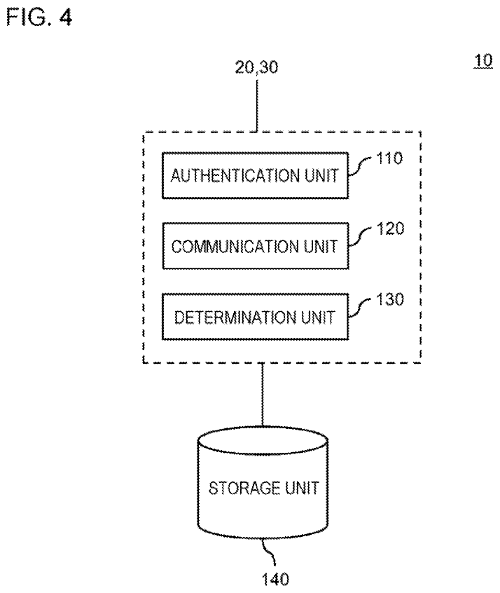

FIG. 4 is a diagram illustrating one example of a functional configuration of the communication apparatus 10. The communication apparatus 10 includes the authentication unit 110, the communication unit 120, and a determination unit 130, and can use a storage unit 140. In the example illustrated in FIG. 4, the storage unit 140 is a part of the communication apparatus 10, but may be located outside the communication apparatus 10.

As described by using FIG. 1, the authentication unit 110 authenticates a target person. The authentication unit 110 may authenticate a target person by using identification information about the target person, for example, an ID, or may authenticate a target person by using biometric information about the target person. One example of the biometric information is at least one of face information, iris information, fingerprint information, and vein information, which is not limited thereto. The authentication unit 110 acquires the information needed for the authentication from the second terminal 30 via the communication unit 120. Further, the authentication unit 110 acquires information being a master of the authentication from the storage unit 140.

Furthermore, the authentication unit 110 may dynamically switch criteria for the authentication processing. An example of a method for switching the criteria for the authentication processing will be described below.

For example, a stricter criterion for authentication has the advantage of increasing accuracy of the authentication of the target person. However, requirement for the criterion for the authentication that is excessively strict may result in a heavy load on the authentication processing and a time-consuming authentication processing.

Therefore, the authentication unit 110 may switch the criteria for the authentication processing by using existing machine learning techniques or optimization methods. As one example, the authentication unit 110 may use a machine learning model that receives as input information relating to a time and frequency at which the authentication processing was performed for the target person and determines the conditions required for the authentication process for the target person. For example, the input information is historical data relating to authentication processing performed for each target person and stored in an authentication result information storage unit, not shown.

For example, the machine learning model determines that the criteria for authentication processing will be relaxed, for a target person whose frequency of performing authentication processing is higher than a predetermined threshold or for a target person for whom the number of performing authentication processing within a predetermined period is equal to or more than a predetermined number. For a target person whose frequency of successful authentications is higher than the predetermined threshold or for a target person for whom the number of performing authentication processing within the predetermined period is equal to or more than the predetermined number, the machine learning model may determine that a frequency of requesting authentication should be reduced. On the other hand, for a target person whose frequency of performing authentication processing is not higher than the predetermined threshold or for a target person for whom the number of performing authentication processing within the predetermined period is less than the predetermined number of times, the machine learning model determine to tighten the criteria for authentication processing

The authentication unit 110 can search for (or optimize) the appropriate first condition by using such a machine learning model.

In this way, by using the machine learning model created from historical data relating to the authentication processing, the authentication unit 230 can set a criterion for the authentication processing that can reduce a load of the authentication processing and a burden on the target person as much as possible, while maintaining authentication accuracy.

The communication unit 120 transmits and receives information to and from the first terminal 20, and also transmits and receives information to and from the second terminal 30. A specific example of the information transmitted and received by the communication unit 120 will be described in a usage example of the communication apparatus 10 described below.

The determination unit 130 determines, for the communication unit 120, whether transmission/reception of information to and from the first terminal 20 is enabled. For example, when a predetermined condition is not satisfied, the determination unit 130 does not permit the communication unit 120 to communicate with the first terminal 20. In other words, when the predetermined condition is not satisfied, the communication unit 120 does not perform communication with the first terminal 20. For example, when the target person is a resident in a facility, the predetermined condition is that there is a predetermined input from an assistant of the resident. For example, the predetermined input indicates that contact with a relative is permitted.

The storage unit 140 stores, by target person, information about the target person. One example of the information is information being a master of authentication.

Note that, in a case of the example illustrated in FIG. 1, the communication apparatus 10 is preferably a portable terminal such as a smartphone and a tablet type terminal. Further, the communication apparatus 10 also further has functions the same as the second terminal 30 as described above.

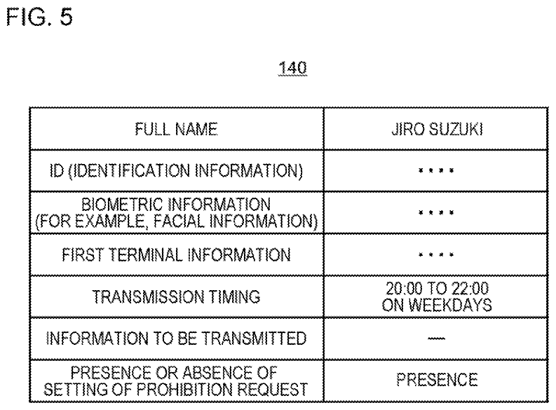

FIG. 5 is a diagram illustrating one example of information stored in the storage unit 140. The storage unit 140 stores, by target person, a name, identification information, biometric information being a master, first terminal information, transmission timing information, information to be transmitted, and presence or absence of setting of a prohibition request.

The identification information and the biometric information being the master are used when the authentication unit 110 performs authentication processing. The storage unit 140 may not store one of the identification information and the biometric information. Note that, the storage unit 140 may store a password together with the identification information. In this case, the authentication unit 110 authenticates a target person by using a combination of the identification information and the password.

The first terminal information stores information needed when the communication unit 120 is connected to the first terminal 20 associated with the target person. The first terminal information is, for example, at least one of a phone number, an e-mail address, and an account of an SNS (Social Networking Service).

The transmission timing information indicates timing at which there is a high possibility that a user of the first terminal 20 operates the first terminal 20. In other words, the transmission timing information indicates timing at which information is preferably transmitted from the communication apparatus 10 to the first terminal 20. The timing is indicated by, for example, a time period by day of a week, which is not limited thereto.

The transmission timing information may be set by a manual input from the target person, an assistant, or the user of the first terminal 20, or may be set based on an operation history of the first terminal 20. In the latter case, for example, the determination unit 130 of the communication apparatus 10 acquires, from the first terminal 20, an access history to information transmitted from the communication unit 120, aggregates, by day of a week, a time period in which an access frequency is high in this access history, and sets the transmission timing information by using this aggregation result. Note that, the determination unit 130 may set the transmission timing information by using an access history to an SNS by the first terminal 20.

Note that, the transmission timing information may not be set.

The “information to be transmitted” in the storage unit 140 in FIG. 5 is an area of a field (one of items in a record) in which information needed to be transmitted to the first terminal 20 is stored. The communication unit 120 acquires, from the second terminal 30, for example, the information to be transmitted to the first terminal 20, but may not immediately transmit the information to the first terminal 20. One example of this case is, for example, a case where the transmission timing information described above is set. In such a case, the communication unit 120 stores the information acquired from the second terminal 30 in the area of the field “information to be transmitted” in the storage unit 140. Note that, the information to be transmitted may be deleted or left as it is after the information is transmitted to the first terminal 20.

The presence or absence of setting of a prohibition request indicates whether to allow a person other than a target person, for example, an assistant to recognize reply information being information to be output from the second terminal 30 when the reply information is received from the first terminal 20. When there is the setting, the communication unit 120 transmits, to the second terminal 30, the reply information together with prohibition request information indicating that the information should not be recognized by a person other than the target person.

Note that, the presence or absence of setting of a prohibition request may be set by kind of information. The kind of information is, for example, text data, an image, and a sound, which is not limited thereto. For example, setting that viewing by a person other than a target person is not prohibited for text data, but viewing by a person other than the target person is prohibited in a case of an image can be achieved.

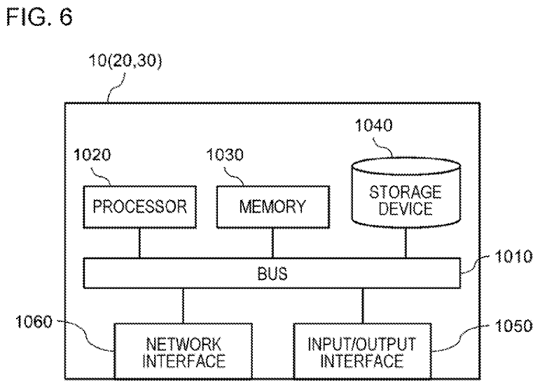

FIG. 6 is a diagram illustrating a hardware configuration example of the communication apparatus 10. The communication apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to one another is not limited to bus connection.

The processor 1020 is a processor implemented by a central processing unit (CPU), a graphics processing unit (GPU), and the like.

The memory 1030 is a main storage apparatus implemented by a random access memory (RAM) and the like.

The storage device 1040 is an auxiliary storage apparatus implemented by a hard disk drive (HDD), a solid state drive (SSD), a removable medium such as a memory card, a read only memory (ROM), or the like, and includes a storage medium. The storage medium of the storage device 1040 stores a program module that implements each function (for example, the authentication unit 110, the communication unit 120, and the determination unit 130) of the communication apparatus 10. The processor 1020 reads each program module onto the memory 1030 and executes the program module, and each function associated with the program module is implemented. The storage device 1040 may further function as the storage unit 140.

The storage medium storing the program module may include a non-transitory tangible medium usable by the computer 1000, and a program code readable by the computer 1000 (the processor 1020) may be embedded in the medium.

The input/output interface 1050 is an interface for connecting the communication apparatus 10 and various types of input/output equipment.

The network interface 1060 is an interface for connecting the communication apparatus 10 to a network. The network is, for example, a local area network (LAN) and a wide area network (WAN). A method of connection to the network by the network interface 1060 may be wireless connection or wired connection. For example, the communication apparatus 10 communicates with the first terminal 20 and the second terminal 30 via the network interface 1060.

Note that, a hardware configuration of the first terminal 20 and the second terminal 30 is also similar to the hardware configuration illustrated in FIG. 6. In this case, the storage medium of the storage device 1040 stores a program module that implements each function of the first terminal 20 and the second terminal 30.

The storage medium storing the program module may include a non-transitory tangible medium usable by the computer 1000, and a program code readable by the computer 1000 (the processor 1020) may be embedded in the medium.

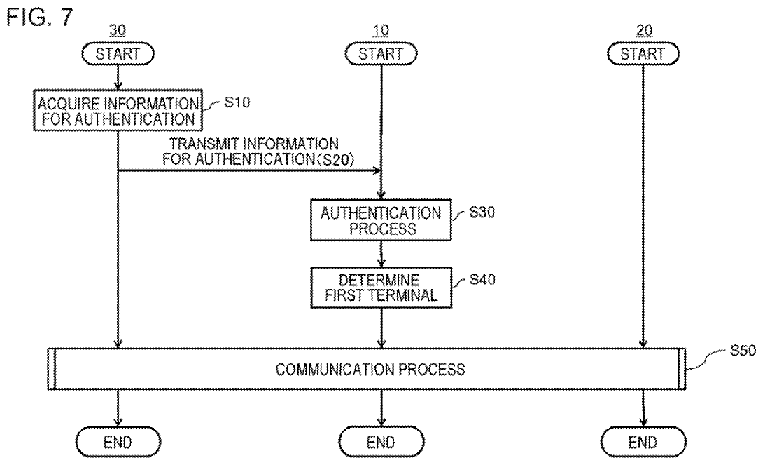

FIG. 7 is a flowchart illustrating one example of an operation performed by the communication apparatus 10. The example illustrated in FIG. 7 is associated with the example illustrated in FIG. 2.

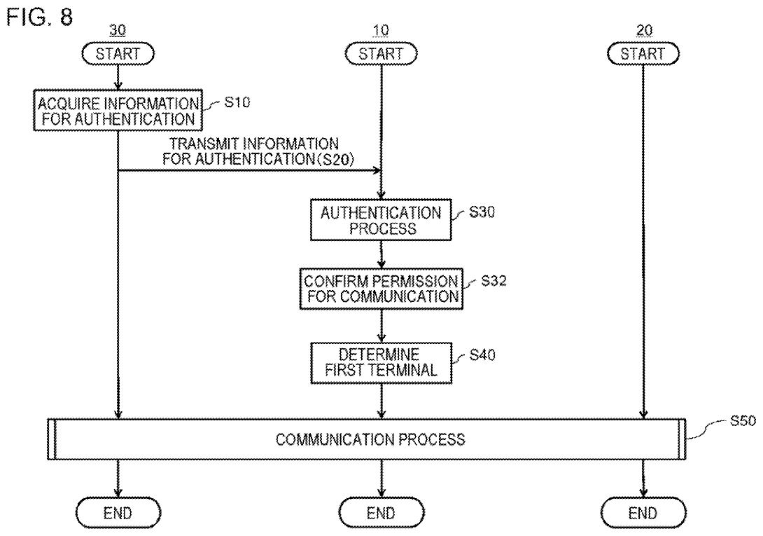

However, in the case of the example illustrated in FIG. 1, the communication apparatus 10 also performs processing indicated in step S10 in FIG. 7. Further, processing indicated in step S20 is not performed. This is also similar in an example illustrated in FIG. 8 described below.

When communication needs to be performed between a target person or an assistant, and a user of the first terminal 20, the second terminal 30 first acquires information needed for authenticating the target person, i.e., authentication information. For example, when the authentication information is face information, the input unit 310 of the second terminal 30 generates an image including a face of the target person. This image may be a moving image, or may be a still image. On the other hand, when the authentication information is identification information such as an ID, the second terminal 30 acquires the identification information via an input apparatus such as a touch panel (step S10).

Then, the communication unit 320 of the second terminal 30 transmits the authentication information to the communication apparatus 10 (step S20). The communication unit 120 of the communication apparatus 10 acquires the authentication information. Next, the authentication unit 110 of the communication apparatus 10 authenticates the target person by using the authentication information, and information being stored in the storage unit 140. At this time, the target person is also determined (step S30).

Next, the communication unit 120 of the communication apparatus 10 reads, from the storage unit 140, first terminal information associated with the target person determined in step S30. In this way, the first terminal 20 being a communication partner this time is determined (step S40).

Subsequently, the communication apparatus 10 transmits and receives information to and from the first terminal 20, and also transmits and receives information to and from the second terminal 30. The transmitted and received information includes at least one of a sound, an image, and text data. In this way, the first terminal 20 and the second terminal 30 can transmit and receive the information via the communication apparatus 10. Note that, a specific example of the processing performed herein will be described below by using another diagram (step S50).

Note that, in step S20, the communication unit 320 of the second terminal 30 may transmit, to the communication apparatus 10, information needed to be transmitted to the first terminal 20 together with the authentication information. One example of the information transmitted herein is a message needed to be notified from the target person to the user of the first terminal 20. This message may be a video message, only a sound, or text data. Further, when the authentication information is an image, the authentication information may also function as a message. Such an example is suitable when this image is a moving image.

FIG. 8 is a diagram illustrating a modification example of FIG. 7. In the example illustrated in FIG. 8, processing until step S30 is similar to the processing in the example illustrated in FIG. 7. After authentication of a target person by the authentication unit 110 of the communication apparatus 10 has succeeded (step S30), the determination unit 130 of the communication apparatus 10 confirms that communication with the first terminal 20 is permitted (step S32).

For example, a case where a target person is a resident in a facility, and the communication apparatus 10 is operated by an assistant of the resident is considered. In this case, when information indicating permission for communication is input from the assistant, the determination unit 130 decides that the communication with the first terminal 20 is permitted. Note that, in the present example, the communication apparatus 10 may be a portable terminal, a desktop personal computer, or a notebook computer. Further, the input of the information by the assistant may be performed via a terminal different from the communication apparatus 10.

Subsequent processing (steps S40 and S50) is as described by using FIG. 7. Note that, in step S32, when it cannot be confirmed that the communication with the first terminal 20 is permitted, the processing indicated in steps S40 and S50 is not performed.

### First Specific Example of Step S50

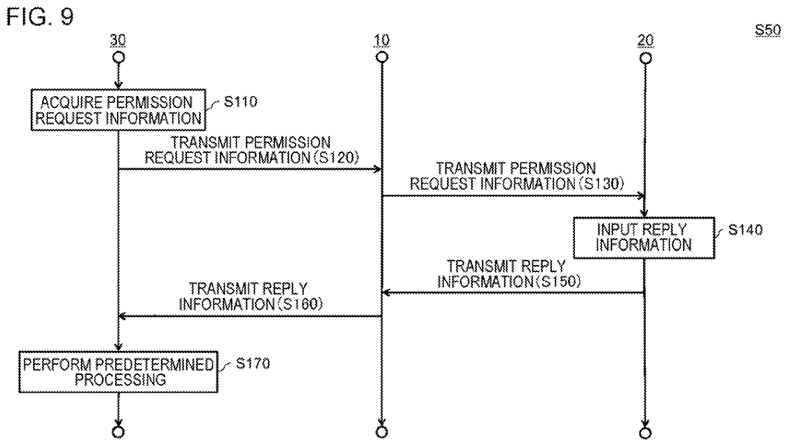

FIG. 9 is a flowchart illustrating a first specific example of step S50. The example illustrated in FIG. 9 illustrates a case where a target person requests a predetermined permission from a user of the first terminal 20. For example, when the target person is a resident in a facility, and the user of the first terminal 20 is a relative of the resident, permission by the relative may be needed when a desire of the resident is to be achieved. The example illustrated in FIG. 9 illustrates communication performed in such a case. Note that, the second terminal 30 may be operated by the resident, or may be operated by an assistant.

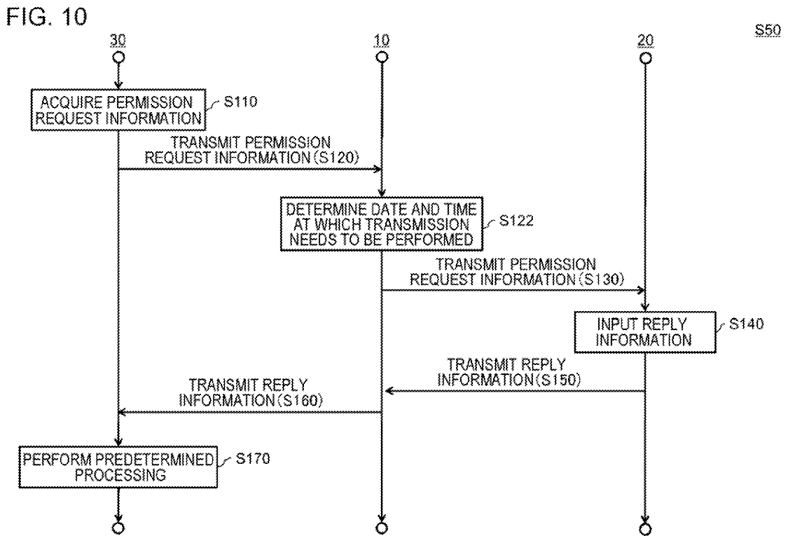

The example illustrated in FIG. 9 is associated with the example illustrated in FIG. 2. However, in the case of the example illustrated in FIG. 1, the communication apparatus 10 also performs processing indicated in steps S110 and S170 in FIG. 9. Further, processing indicated in steps S120 and S160 is not performed. This is also similar in an example illustrated in FIG. 10 described below.

First, the communication unit 320 of the second terminal 30 acquires permission request information (step S110). The acquisition is performed via, for example, an input apparatus included in the second terminal 30. The permission request information indicates a request to the relative to give the predetermined permission to the target person. For example, the predetermined permission indicates that the resident is allowed to purchase a specific product or a specific service, which is not limited thereto. For example, the predetermined permission may be permission for the resident to go out. The permission request information may be, for example, text data or a moving image.

Then, the communication unit 320 of the second terminal 30 transmits the permission request information to the communication apparatus 10 (step S120). When the communication unit 120 of the communication apparatus 10 acquires the permission request information, the communication unit 120 transmits the permission request information to the first terminal 20 (step S130).

The communication unit 120 of the communication apparatus 10 may further transmit decision support information useful for making the decision whether or not to comply with a request indicated by the permission request information. The decision support information is, for example, an attention level of the permission request information. The attention level of the permission request information is a degree of the attention required when deciding whether or not to comply with the request indicated by the permission request information. The attention level of the permission request information may be generated using a machine learning model that has learned trends of the permission request information transmitted and received in the past. The trends of the permission request information transmitted and received in the past includes information indicating content of the request indicated by the permission request information, and information indicating content of a response to the request (whether or not it was complied with). The machine learning model is, for example, a model learned by the history of permission request information. The history of permission request information may include, but is not limited to, for example, a content of a predetermined permission and frequency with which the permission request information is transmitted and received.

In the example illustrated in FIG. 9, the transmission is performed in real time.

The communication unit 220 of the first terminal 20 acquires the permission request information from the communication apparatus 10. Then, the output unit 230 outputs the permission request information, and causes the user of the first terminal 20 to recognize the permission request information. At this time, the first terminal 20 may further cause another terminal such as a television and an intercom to perform a predetermined output in order to cause the user to recognize that the permission request information is transmitted. In this way, the user of the first terminal 20 can easily recognize that information is transmitted from the communication apparatus 10.

The first terminal 20 communication unit 220 may further acquire the attention level of the permission request information. The output unit 230 then outputs this attention level of the permission request information to make the user of the first terminal 20 aware of the attention level of the permission request information. In this way, it is possible to assist the user of the first terminal 20 in making decision whether or not to comply with a request indicated by the permission request information.

Note that, the output unit 230 may first output only a fact that the permission request information is transmitted, and may then output the permission request information after a predetermined input is performed. Further, after the permission request information is output, the communication unit 220 may transmit, to the communication apparatus 10, information indicating the output, for example, an open notification. In this case, the communication apparatus 10 preferably transmits the information indicating that the permission request information has been output to the second terminal 30.

When the user of the first terminal 20 determines whether to respond to the permission request information, the user inputs information indicating the determined content to the first terminal 20. Hereinafter, the information being input herein will be described as reply information (step S140). Herein, when the output unit 230 includes a touch panel, the output unit 230 may display a button indicating permission and a button indicating non-permission on this touch panel. In this case, the user of the first terminal 20 performs the input on the first terminal 20 by selecting one of the buttons.

Then, the communication unit 220 of the first terminal 20 transmits the input reply information to the communication apparatus 10 (step S150). The communication unit 120 of the communication apparatus 10 transmits, to the second terminal 30, the reply information acquired from the first terminal 20 (step S160). Then, the output unit 330 of the second terminal 30 outputs the reply information. Further, the second terminal 30 performs predetermined processing according to the reply information (step S170).

The communication unit 320 does not need to transmit all permission request information, but may adjust (or optimize) a frequency of transmitting the permission request information to the communication apparatus 10.

The reason is that constantly monitoring every purchase behavior or specific behavior of the target person may have a negative impact on the target person. For example, if the target person is an elderly person, requiring permission request information for every purchase behavior may harm the dignity of the elderly person. If the target person is a child, requesting permission request information for any purchase behavior may have a negative impact on a growth and personality of the child.

An example of a method performed by the communication unit 320 of adjusting (or optimizing) the frequency of permission request information is, for example, transmitting, to the communication apparatus 10, the permission request information only relating to purchase actions that satisfies a specific condition. Specifically, the communication unit 320 may transmit the permission request information to the communication apparatus 10 when the amount of products or services purchased by the target person exceeds a predetermined threshold value. Alternatively, the communication unit 320 may transmit the permission request information only when purchase behavior is determined to be abnormal by abnormality detection using an existing machine learning model.

For example, when the permission request information indicates that the target person requests permission to purchase a specific product or a specific service, and the reply information indicates that this purchase is permitted, the second terminal 30 performs processing for advancing the purchase processing, for example, processing of accessing a page related to the specific product or the specific service on an EC (Electronic Commerce) site. A URL (Uniform Resource Locator) related to the specific product or the specific service on the EC site is included in, for example, the permission request information. In this case, the reply information may also include the URL. Then, the second terminal 30 accesses the EC site by using the URL included in the permission request information or the reply information. Further, the second terminal 30 may perform processing until the purchase processing of the product or the service. Note that, a purchase target may be an electronic book and a license of a game.

Further, the communication unit 120 of the communication apparatus 10, or the output unit 330 of the second terminal 30 may generate recommendation information for the target person by using information about a product or a service indicated by the permission request information, for example, a kind of the product or the service. The recommendation information is, for example, information for introducing a product or a service similar to a product or a service indicated by the permission request information. Then, the second terminal 30 performs an output, for example, display of the recommendation information. The recommendation information may include a search result of a product or a service indicated by the permission request information.

Note that, for example, when the target person is an old person who resides in a facility, the EC site may be a site for an old person. This site performs display by narrowing down products and services for an old person. Thus, the target person or the user of the first terminal 20 can easily select a product or a service desired by the target person. Further, there is a lower possibility that the target person or the user of the first terminal 20 mistakenly purchases a product or a service not suitable for an old person.

Further, in the example illustrated in FIG. 9, the first terminal 20 may also be operated by a resident in a facility or an assistant, and the second terminal 30 may also be operated by a relative of the resident. In this case, the permission request information indicates a product or a service recommended to the resident by the relative. Then, the reply information indicates whether or not the resident desires to purchase the product or the service. Note that, actual purchase processing may be performed by the resident or the assistant, or may be performed by the relative.

Note that, when the target person is a resident in a facility, and a medicine needs to be taken, timing at which an output of the reply information and predetermined processing is performed, i.e., timing at which step S170 is performed may be timing at which the medicine is taken.

### Second Specific Example of Step S50

FIG. 10 is a flowchart illustrating a second specific example of step S50. The example illustrated in FIG. 10 is similar to the specific example illustrated in FIG. 9 except for a point that timing at which the communication apparatus 10 transmits permission request information to the first terminal 20 is not in real time, and is preset by target person.

In FIG. 10, processing until step S120 is similar to the processing in the example illustrated in FIG. 9. When the communication unit 120 of the communication apparatus 10 acquires permission request information from the second terminal 30, the communication unit 120 reads, from the storage unit 140, transmission timing associated with a target person determined in step S30 in FIG. 7. In this way, the communication unit 120 determines a date and time at which the permission request information needs to be transmitted (step S122). Then, the communication unit 120 transmits the permission request information to the first terminal 20 on the determined date and time (step S130).

Subsequent processing (steps S140 to S170) is similar to the processing in the example illustrated in FIG. 9. Note that, also in another example described below, similarly to the present example, the processing indicated in steps S122 and S130 may be performed.

### Third Specific Example of Step S50

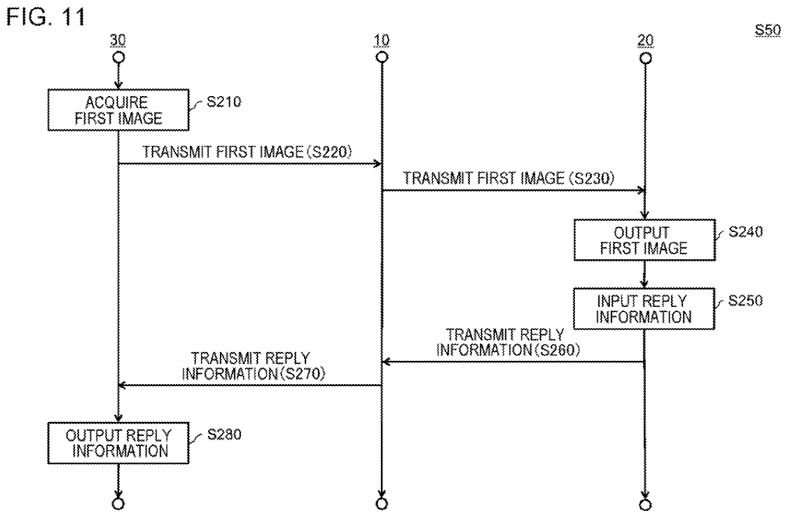

FIG. 11 is a flowchart illustrating a third specific example of step S50. The example illustrated in FIG. 11 illustrates a case where images in which a target person and a user of the first terminal 20 are captured by each other are transmitted between the target person and the user. The image is preferably a moving image, but may be a still image. Further, text data may be used instead of the image.

The example illustrated in FIG. 11 is associated with the example illustrated in FIG. 2. However, in the case of the example illustrated in FIG. 1, the communication apparatus 10 also performs processing indicated in steps S210 and S280 in FIG. 11. Further, processing indicated in steps S220 and S270 is not performed.

One example of the target person is a resident in a facility. In this case, the user of the first terminal 20 is a relative of the target person. Conversely, the target person may be a relative of a resident in a facility, and the user of the first terminal 20 may be the resident in the facility.

First, the target person or an assistant causes the second terminal 30 to generate an image needed to be transmitted from the target person to the user of the first terminal 20, for example, a video message. Hereinafter, this image will be described as a first image. The first image is generated by, for example, capturing the target person. Note that, the first image may be a message from the target person to the user of the first terminal 20, or may be an image in which a daily operation of the target person is captured (step S210). Next the communication unit 320 of the second terminal 30 transmits the first image to the communication apparatus 10 (step S220). Note that, when the communication apparatus 10 has a capturing function, the communication apparatus 10 may directly generate the first image.

Note that, the first image may be an image used when the target person is authenticated. As described by using FIG. 7, this image may be a moving image, or may be a still image. In this case, the processing indicated in steps S210 and S220 may be not performed.

Next, the communication unit 120 of the communication apparatus 10 transmits the first image to the first terminal 20 (step S230).

The communication unit 220 of the first terminal 20 acquires the first image from the communication apparatus 10. Then, the output unit 230 of the first terminal 20 outputs the first image (step S240). In this way, the user of the first terminal 20 can recognize the first image.

Then, the user of the first terminal 20 inputs, to the first terminal 20, information to be transmitted to the target person. Hereinafter, the information will be described as reply information. For example, the first terminal 20 generates a second image as at least a part of the reply information by using the input unit 210. The second image may be an image in which the user viewing the first image is captured, or may be an image in which the user after viewing the first image is captured. This example is suitable when the second image is a message from a relative of the resident in the facility to the resident, for example (step S250).

In other words, the communication apparatus 10 of the communication unit 120 receives from the first terminal 20, a second image in which the relative is captured after the first image is transmitted.

Then, the communication unit 220 of the first terminal 20 transmits the reply information to the communication apparatus 10 (step S260). When the communication unit 120 of the communication apparatus 10 receives the reply information from the first terminal 20, the communication unit 120 transmits the reply information to the second terminal 30 (step S270).

The communication unit 320 of the second terminal 30 acquires the reply information. Then, the output unit 330 of the second terminal 30 outputs the reply information, and causes the target person to recognize the reply information (step S280). Note that, when the reply information includes a moving image, and a reproduction time of the moving image is equal to or more than a reference value, the communication unit 320 may divide and output the moving image, or may fast-forward and output the moving image.

### Fourth Specific Example of Step S50

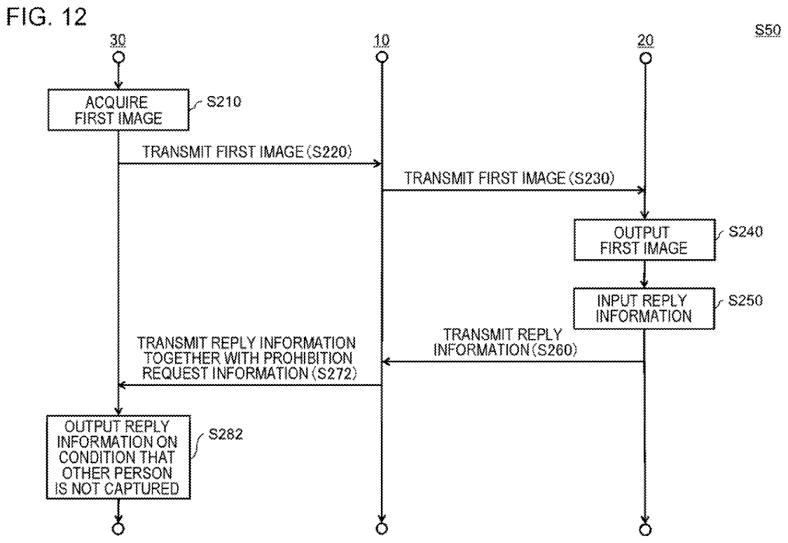

FIG. 12 is a flowchart illustrating a fourth specific example of step S50. The example illustrated in FIG. 12 is similar to the specific example illustrated in FIG. 11 except for a point that the communication apparatus 10 transmits prohibition request information together with reply information, and a point that the output unit 330 of the second terminal 30 operates based on the prohibition request information. The prohibition request information indicates that a person other than a target person is prohibited from recognizing the reply information.

The example illustrated in FIG. 12 is associated with the example illustrated in FIG. 2. However, in the case of the example illustrated in FIG. 1, the communication apparatus 10 also performs processing indicated in steps S210 and S282 in FIG. 12. Further, processing indicated in steps S220 and S272 is not performed.

In FIG. 12, processing until step S260 is similar to the processing in the example illustrated in FIG. 11. When the communication unit 120 of the communication apparatus 10 acquires the reply information from the first terminal 20, the communication unit 120 confirms, from the storage unit 140, whether a prohibition request is set for a target person determined in step S30 in FIG. 7. In other words, the communication unit 120 decides whether it is necessary to prohibit a person other than a resident from recognizing the reply information, based on the target person. When there is no setting of the prohibition request, processing similar to the processing in FIG. 11 is subsequently performed. On the other hand, when there is the setting of the prohibition request, the communication unit 120 performs processing for prohibiting a person other than the resident from recognizing the reply information. In the example illustrated in FIG. 12, the communication unit 120 transmits the reply information together with the prohibition request information to the second terminal 30 (step S272). It means that, in the processing, the communication unit 120 decides whether transmission of the prohibition request information is necessary, based on the target person.

Subsequently, the second terminal 30 causes the output unit 330 to output the reply information while performing capturing by the input unit 310. Herein, the output unit 330 outputs the reply information only while a face of the target person is detected from an image captured by the input unit 310. Further, when a person other than the target person is detected from the image captured by the input unit 310, the output unit 330 does not perform an output of the reply information. Further, when a person other than the target person is detected from the image captured by the input unit 310 during an output of the reply information, the output of the reply information is interrupted, and then, when only the target person is detected from the image captured by the input unit 310, the output of the reply information is restarted (step S282).

Note that, in the example illustrated in FIG. 12, processing of an image captured by the input unit 310 is performed by the second terminal 30. However, the processing may be performed by the communication apparatus 10. In this case, every time the input unit 310 generates an image, for example, a frame image, the input unit 310 transmits the image to the communication apparatus 10. Then, the authentication unit 110 of the communication apparatus 10 decides whether an image of the target person is being detected from the acquired image, and whether a person other than the target person is being detected from this image, and transmits a decision result to the second terminal 30. Then, the output unit 330 of the second terminal 30 controls the output of the reply information by using the decision result acquired from the communication apparatus 10.

Information transmitted and received in step S50 is not limited to the first to fourth specific examples described above. For example, when a target person is a resident in a facility, the second terminal 30 is operated by an assistant of the target person, and a user of the first terminal 20 is a relative of the target person, the information transmitted and received in step S50 may be a contact matter between the facility and the relative, for example, a request from the facility to the relative and a reply to the request. Further, when face authentication is used in step S30, information transmitted to the first terminal 20 in step S50 after a same target person uses the communication apparatus 10 for a plurality of times may be generated by automatically editing an image used in step S30.

As described above, the present example embodiment can assist in communication between a plurality of persons. Further, when reply information is transmitted from the first terminal 20 to the second terminal 30, and a prohibition request is set for a target person, the second terminal 30 does not perform an output of the reply information in a case where a person other than the target person is detected from an image captured by the input unit 310. Thus, privacy of the target person can also be ensured.

While the example embodiments of the present invention have been described with reference to the drawings, the example embodiments are only exemplification of the present invention, and various configurations other than the above-described example embodiments can also be employed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

1. A communication apparatus including:
an authentication unit that authenticates a target person; and
a communication unit that transmits and receives information to and from a first terminal being associated with the target person and being operated by a different person from the target person when the authentication has succeeded, wherein
at least a part of the information transmitted by the communication unit to the first terminal is related to the target person, and
at least a part of the information received by the communication unit from the first terminal includes information from the different person to the target person.

2. The communication apparatus according to supplementary note 1, wherein
the first terminal is operated by a relative of the target person.

3. The communication apparatus according to supplementary note 2, wherein
the communication unit
   transmits, to the first terminal, permission request information indicating a request to the relative to give the predetermined permission to the target person, and
   receives reply information for the permission request information from the first terminal.

4. The communication apparatus according to supplementary note 3, wherein
the predetermined permission is permission to purchase a product or a service, and
the communication unit generates recommendation information for the target person by using information about the product or the service.

5. The communication apparatus according to supplementary note 2, wherein
the communication unit transmits, to the first terminal, a first image in which the target person is captured.

6. The communication apparatus according to supplementary note 5, wherein
the communication unit acquires the first image from a capturing apparatus that captures the target person.

7. The communication apparatus according to supplementary note 5 or 6, wherein
the communication unit
   receives, from the first terminal, a second image in which the relative is captured after the first image is transmitted.

8. The communication apparatus according to any one of supplementary notes 1 to 7, further including
a determination unit that determines, for the communication unit, whether transmission/reception of information to and from the first terminal is enabled.

9. The communication apparatus according to any one of supplementary notes 1 to 8, wherein
the communication unit transmits information to the first terminal at timing being preset for the target person.

10. The communication apparatus according to any one of supplementary notes 1 to 9, wherein
the first terminal is operated by a relative of a resident in a facility, and
the communication unit
   receives, from the first terminal, reply information needed to be notified to the resident after the authentication has succeeded, and
   performs processing for prohibiting a person other than the resident from recognizing the reply information.

11. The communication apparatus according to supplementary note 10, wherein
the communication unit decides whether the prohibition is necessary, based on the target person.

12. A communication method including,
by at least one computer:
authenticating a target person; and
transmitting and receiving information to and from a first terminal being associated with the target person and being operated by a different person from the target person when the authentication has succeeded, wherein
at least a part of information transmitted to the first terminal is related to the target person, and
at least a part of information received from the first terminal includes information from the different person to the target person.

13. The communication method according to supplementary note 12, wherein
the first terminal is operated by a relative of the target person.

14. The communication method according to supplementary note 13, further including, by the computer:
transmitting, to the first terminal, permission request information indicating a request to the relative to give the predetermined permission to the target person; and
receiving reply information for the permission request information from the first terminal.

15. The communication method according to supplementary note 14, wherein
the predetermined permission is permission to purchase a product or a service,
the communication method further including,
by the computer, generating recommendation information for the target person by using information about the product or the service.

16. The communication method according to supplementary note 13, further including,
by the computer, transmitting, to the first terminal, a first image in which the target person is captured.

17. The communication method according to supplementary note 16, further including,
by the computer, acquiring the first image from a capturing apparatus that captures the target person.

18. The communication method according to supplementary note 16 or 17, further including,
by the computer,
receiving, from the first terminal, a second image in which the relative is captured after the first image is transmitted.

19. The communication method according to any one of supplementary notes 12 to 18, further including,
by the computer, determining whether transmission/reception of information to and from the first terminal is enabled.

20. The communication method according to any one of supplementary notes 12 to 19, further including,
by the computer, transmitting information to the first terminal at timing being preset for the target person.

21. The communication method according to any one of supplementary notes 12 to 20, wherein
the first terminal is operated by a relative of a resident in a facility,
the communication method further including,
by the computer:
receiving, from the first terminal, reply information needed to be notified to the resident after the authentication has succeeded; and
performing processing for prohibiting a person other than the resident from recognizing the reply information.

22. The communication method according to supplementary note 21, further including,
by the computer, deciding whether the prohibition is necessary, based on the target person.

23. A program causing a computer to:
authenticate a target person; and
transmit and receive information to and from a first terminal being associated with the target person and being operated by a different person from the target person when the authentication has succeeded, wherein
at least a part of information transmitted to the first terminal is related to the target person, and
at least a part of information received from the first terminal includes information from the different person to the target person.

24. The program according to supplementary note 23, wherein
the first terminal is operated by a relative of the target person.

25. The program according to supplementary note 24, further causing the computer to:
transmit, to the first terminal, permission request information indicating a request to the relative to give the predetermined permission to the target person; and
receive reply information for the permission request information from the first terminal.

26. The program according to supplementary note 25, wherein
the predetermined permission is permission to purchase a product or a service,
the program further causing the computer to generate recommendation information for the target person by using information about the product or the service.

27. The program according to supplementary note 24, further causing the computer to
transmit, to the first terminal, a first image in which the target person is captured.

28. The program according to supplementary note 27, further causing the computer to acquire the first image from a capturing apparatus that captures the target person.

29. The program according to supplementary note 27 or 28, further causing the computer to
receive, from the first terminal, a second image in which the relative is captured after the first image is transmitted.

30. The program according to any one of supplementary notes 23 to 29, further causing the computer to
determine whether transmission/reception of information to and from the first terminal is enabled.

31. The program according to any one of supplementary notes 23 to 30, further causing the computer to
transmit information to the first terminal at timing being preset for the target person.

32. The program according to any one of supplementary notes 23 to 31, wherein
the first terminal is operated by a relative of a resident in a facility,
the program further causing the computer to:
receive, from the first terminal, reply information needed to be notified to the resident after the authentication has succeeded; and
perform processing for prohibiting a person other than the resident from recognizing the reply information.

33. The program according to supplementary note 32, further causing the computer to
decide whether the prohibition is necessary, based on the target person.

34. A storage medium storing the program according to any one of supplementary notes 23 to 33.

35. The communication apparatus according to supplementary note 2, wherein
the communication unit outputs decision support information useful for making decision whether or not to comply with the request indicated by the permission request information.

36. The communication apparatus according to supplementary note 35, wherein
the decision support information is a degree of attention generated by a machine learning model which has learned trends of the permission request information transmitted and received in the past.

37. The communication apparatus according to any one of supplementary notes 1 to 11 and 35 to 36, wherein
the communication unit changes a criterion for the authentication based on at least one of a time and frequency at which the authentication processing was performed for the target person.

38. The communication method according to supplementary note 13, further including, by the computer:
outputting decision support information useful for making decision whether or not to comply with the request indicated by the permission request information.

39. The communication method according to supplementary note 38, wherein
the decision support information is a degree of attention generated by a machine learning model which has learned trends of the permission request information transmitted and received in the past.

40. The communication method according to any one of supplementary notes 12 to 22, and 38 to 39, further including,
by the computer:
changing a criterion for the authentication based on at least one of a time and frequency at which the authentication processing was performed for the target person.

41. The program according to supplementary note 24, further causing the computer to:
output decision support information useful for making decision whether or not to comply with the request indicated by the permission request information.

42. The program according to supplementary note 41, wherein
the decision support information is a degree of attention generated by a machine learning model which has learned trends of the permission request information transmitted and received in the past.

43. The program according to any one of supplementary notes 23 to 33 and 41 to 42, further causing the computer to:
change a criterion for the authentication based on at least one of a time and frequency at which the authentication processing was performed for the target person.

44. A non-transitory computer-readable storage medium storing the program according to any one of supplementary notes 23 to 33 and 41 to 43.

What is claimed is:

1. A communication apparatus comprising:
at least one memory configured to store instructions; and
at least one processor configured to execute the instructions to:
receive permission request information indicating a request for a permission;
acquire information indicating a transmission timing preset for a subject person; and
transmit the permission request information to a first terminal at the transmission timing.

2. The image acquisition apparatus according to claim 1, wherein
the at least one processor is further configured to perform:
receiving reply information for the permission request information from the first terminal; and
transmitting the reply information to a second terminal used by a person other than a user of the first terminal.

3. The image acquisition apparatus according to claim 2, wherein
the at least one processor is further configured to perform
determining whether transmission/reception of information to and from the first terminal is enabled.

4. The communication apparatus according to claim 2, wherein
the at least one processor is further configured to execute the instructions to perform
prohibiting the person other than the user of the first terminal from recognizing the reply information.

5. The communication apparatus according to claim 1, wherein
the at least one processor is further configured to perform:
acquiring, from the first terminal, an access history to information transmitted from the communication apparatus; and
setting the transmission timing by using the access history.

6. The communication apparatus according to claim 2, wherein
the at least one processor is further configured to perform
outputting decision support information useful for making decision whether or not to comply with the request indicated by the permission request information.

7. A communication method comprising, by a computer:
receiving permission request information indicating a request for a permission;
acquiring information indicating a transmission timing preset for a subject person; and
transmitting the permission request information to a first terminal at the transmission timing.

8. The communication method according to claim 7, further comprising, by the computer:
receiving reply information for the permission request information from the first terminal; and
transmitting the reply information to a second terminal used by a person other than a user of the first terminal.

9. The communication method according to claim 8, further comprising, by the computer,
determining whether transmission/reception of information to and from the first terminal is enabled.

10. The communication method according to claim 8, further comprising, by the computer,
prohibiting the person other than the user of the first terminal from recognizing the reply information.

11. The communication method according to claim 7, further comprising, by the computer:
acquiring, from the first terminal, an access history to information transmitted from the communication apparatus; and
setting the transmission timing by using the access history.

12. A non-transitory computer-readable storage medium storing a program causing a computer to perform:
receiving permission request information indicating a request for a permission;
acquiring information indicating a transmission timing preset for a subject person; and
transmitting the permission request information to a first terminal at the transmission timing.

13. The non-transitory computer-readable storage medium according to claim 12, wherein
the program causes the computer to perform:
receiving reply information for the permission request information from the first terminal; and
transmitting the reply information to a second terminal used by a person other than a user of the first terminal.

14. The non-transitory computer-readable storage medium according to claim 13, wherein
the program causes the computer to perform
determining whether transmission/reception of information to and from the first terminal is enabled.

15. The non-transitory computer-readable storage medium according to claim 13, wherein
the program causes the computer to perform
prohibiting the person other than the user of the first terminal from recognizing the reply information.

16. The non-transitory computer-readable storage medium according to claim 12, wherein
the program causes the computer to perform:
acquiring, from the first terminal, an access history to information transmitted from the communication apparatus; and
setting the transmission timing by using the access history.
